(19) United States
(12) Patent Application Publication
(10) Pub. No.: US 2023/0268666 A1
(43) Pub. Date: Aug. 24, 2023

(54) MODULAR WAVEGUIDE TO PRINTED CIRCUIT BOARD INTERCONNECTED RADAR DESIGN

(71) Applicant: SENSATA TECHNOLOGIES, INC., ATTLEBORO, MA (US)

(72) Inventor: BRIAN K. HANLEY, WESTWOOD, MA (US)

(21) Appl. No.: 18/005,575

(22) PCT Filed: Jul. 14, 2021
(86) PCT No.: PCT/US2021/041564

§ 371 Date: Jan. 13, 2023

Related U.S. Application Data
(60) Provisional application No. 63/057,610, filed on Jul. 28, 2020.

(51) Int. Cl. H01Q 21/00; G01S 7/03; H01Q 21/06

(52) U.S. Cl. CPC H01Q 21/0075; G01S 7/032; H01Q 21/0025; H01Q 21/065

(57) ABSTRACT

Modular waveguide to printed circuit board (PCB) interconnected radar, apparatuses, and methods of using a modular waveguide to PCB interconnected radar are disclosed. In a particular embodiment, a modular waveguide to printed circuit board (PCB) interconnected radar is disclosed that includes a waveguide launch PCB and a waveguide interconnect coupled to the waveguide launch PCB. The radar also includes an antenna launch PCB coupled to the waveguide interconnect.

### TECHNICAL FIELD

The present disclosure relates to electronics. More particularly, this disclosure relates to a modular waveguide to printed circuit board interconnected radar design.

### BACKGROUND

Common antenna designs for use in radar systems include microstrip or stripline type designs and waveguide designs. Microstrip or stripline designs are fabricated as part of a printed circuit board (PCB) design and may be part of a single PCB design where all the radar components and the antenna are contained on a single PCB or part of several PCBs. In the case of several PCBs, transmit and receive circuitry or expensive interconnect components are located on the same PCB as the antenna to prevent excessive electrical losses due to the high frequency of transmissions.

### BRIEF DESCRIPTION OF THE DRAWINGS

FIG. 1 illustrates a microstrip or stripline PCB based antenna design, populated with transmit and receive integrated circuits (ICs).

FIG. 2 illustrates a waveguide antenna (launch PCB not shown).

FIG. 3 illustrates an exploded view of the waveguide to PCB interconnect, single antenna board, with launch PCB including ICs, waveguide interconnect, and antenna board, according to at least one embodiment of the present invention.

FIG. 4 illustrates an exploded view of the waveguide to PCB interconnect, dual antenna boards, with launch PCB including ICs, waveguide interconnects, and dual antenna board, which allows for greater than 180 degree field of view, according to at least one embodiment of the present invention.

FIG. 5 is a flowchart of an example method for a modular waveguide to PCB interconnected radar design according to at least one embodiment of the present invention.

FIG. 6 is another flowchart of an example method for a modular waveguide to PCB interconnected radar design according to at least one embodiment of the present invention.

### SUMMARY OF INVENTION

In a particular embodiment, a modular waveguide to printed circuit board (PCB) interconnected radar is disclosed that includes a waveguide launch PCB and a waveguide interconnect coupled to the waveguide launch PCB. The radar also includes an antenna launch PCB coupled to the waveguide interconnect.

In a particular embodiment, a method includes receiving, by an antenna launch PCB, from a waveguide launch PCB via a waveguide interconnect, a radio frequency (RF) signal. The method also includes rerouting the RF signal to a final antenna structure of the antenna launch PCB. The method further includes broadcasting the RF signal via the final antenna structure.

As will be explained in greater detail below, the waveguide launch PCB is able to generate an RF signal that is provided to the antenna launch PCB via the waveguide interconnect. The RF signal received at the antenna launch PCB is rerouted to a final antenna structure and broadcast by the final antenna structure. This modular design allows for the antenna launch PCB to be an unpopulated PCB, reducing cost and design complication. Moreover, multiple antenna launch PCBs may be used to increase the broadcast angle of the RF signal.

### DETAILED DESCRIPTION

The terminology used herein for the purpose of describing particular examples is not intended to be limiting for further examples. Whenever a singular form such as “a”, “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

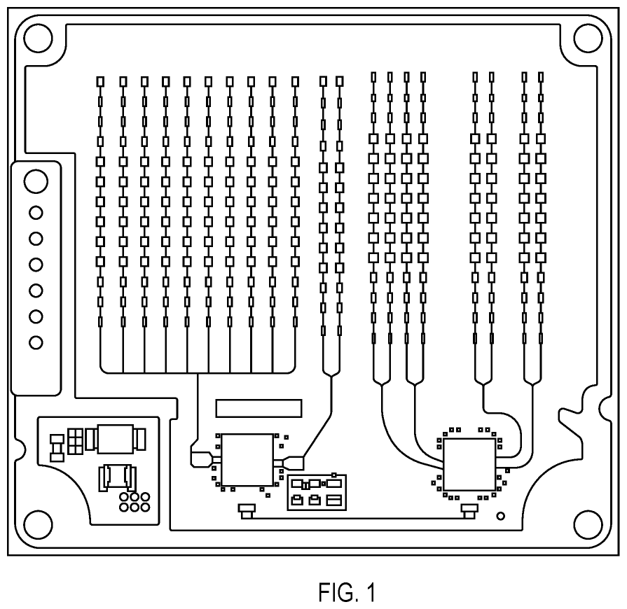

Common antenna designs for use in radar systems include microstrip or stripline type designs and waveguide designs. Microstrip or stripline designs are fabricated as part of a printed circuit board (PCB) design, such as those seen in FIG. 1, and may be part of a single PCB design where all the radar components and the antenna are contained on a single PCB or part of several PCBs. In the case of several PCBs, transmit and receive circuitry or expensive interconnect components must be located on the same PCB as the antenna to prevent excessive electrical losses due to the high frequency of transmissions. While multiple PCBs may allow for modularity, the antenna PCB cost remains high due to requirements that the transmit and receive ICs or interconnects be populated on the same PCB. Additionally, an individual PCB is limited to planar construction, which limits the maximum field of view of a radar for objects at nearly right angles to the boresight direction of the antenna. In the case of multiple PCBs, field of view can be extended, but each PCB would require transmit and receive ICs to be populated on the same board.

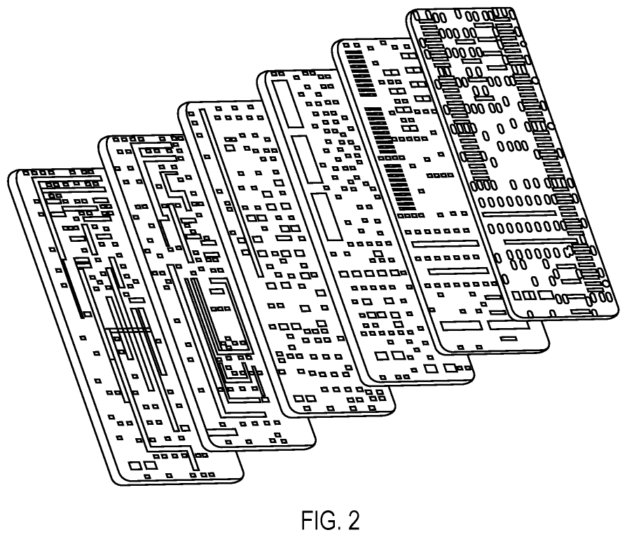

Waveguide designs, such as illustrated in FIG. 2, require at least one PCB to launch from the transmit and receive ICs, which then launches into a series of manufactured plates or waveguide components to redirect into the final antenna launch structure. Waveguide designs provide modularity by allowing an antenna to be changed by replacing only the waveguide structure but are frequently more expensive due to manufacturing tolerances of machined components and required number of plates or waveguide components to create an intended antenna pattern. Waveguide designs can be manufactured to have non-planar antenna designs to widen the field of view relative to a planar antenna while still using the single PCB populated with transmit and receive ICs.

Modular waveguide to printed circuit board (PCB) interconnected radar, apparatuses, and methods of using a modular waveguide to PCB interconnected radar are disclosed. A particular embodiment details the use of a waveguide launch PCB, a simplified waveguide interconnect, and one or more antenna launch PCBs that receive an RF signal via the waveguide interconnect and reroute and broadcast the RF signal to a final antenna structure. In a particular embodiment, the waveguide interconnect may be designed to be a simple molded and plated (or other low-cost manufactured) component. The antenna launch PCB needs no populated components and can be designed using only circuit traces, specifically waveguide receive sections, circuit traces to reroute the signals, and microstrip or stripline sections as the final antenna launch structure. The result is a modular design that allows for lower cost of a microstrip or stripline design and potential for a wider field of view using a single populated PCB.

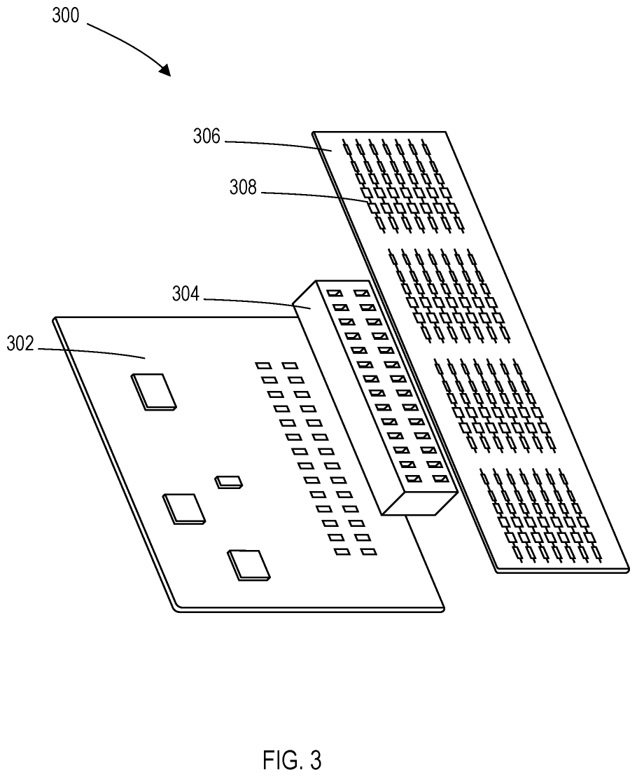

The designs disclosed provide the ability to use a single, effectively universal launch board design that is paired with an interconnect design to one or several antennas. For example, FIG. 3 shows an exploded view of a modular waveguide to printed circuit board (PCB) interconnected radar 300. The radar 300 includes a waveguide launch PCB 302. A waveguide interconnect 304 is coupled to the waveguide launch PCB 302. An antenna launch PCB 306 is also coupled to the waveguide interconnect 304. In other words, the waveguide interconnect 304 serves to couple the antenna launch PCB 306 to the waveguide launch PCB 302. The antenna launch PCB 306 includes a final antenna launch structure 308 configured to broadcast an RF signal received from the waveguide launch PCB 302. In some embodiments, the final antenna launch structure 308 includes one or more microstrip traces. In some embodiments, the final antenna launch structure 308 includes one or more stripline traces.

For example, in some embodiments, the antenna launch PCB 306 includes one or more waveguide receive sections configured to receive an RF signal from the waveguide launch PCB 302. The antenna launch PCB 306 also includes one or more circuit traces coupling the waveguide receive sections to the final antenna launch structure 308. The circuit traces reroute a received RF signal from the waveguide receive sections to the final antenna launch structure 308. The RF signal is then broadcast via the final antenna launch structure 308.

In some embodiments, the antenna launch PCB 306 is an unpopulated PCB. In other words, the antenna launch PCB 306 includes only circuit traces. Thus, the waveguide receive sections, the final antenna structure 308, and the interconnecting circuit traces are all embodied as circuit traces. Thus, only the waveguide launch PCB 302 includes populated components.

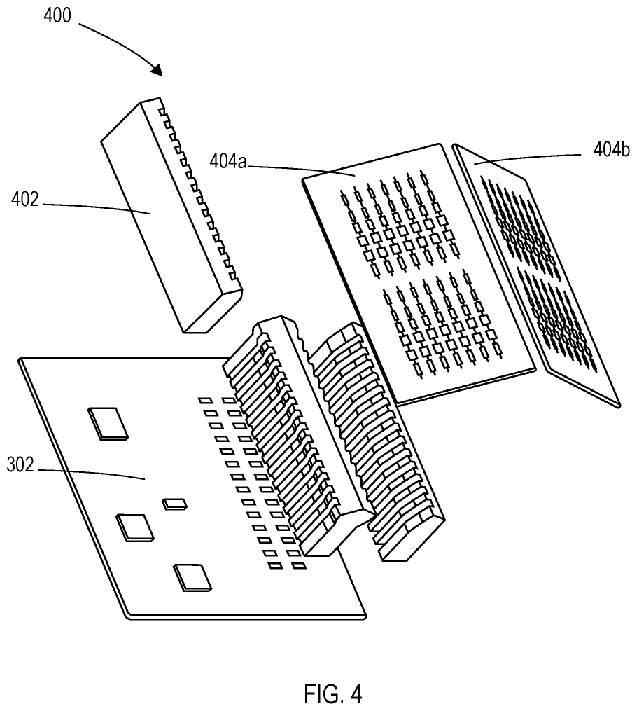

FIG. 4 shows another exploded view of a modular waveguide to printed circuit board (PCB) interconnected radar 400, according to embodiments of the present invention. The radar 400 of FIG. 4 is similar to the radar 300 of FIG. 3 in that the radar 400 includes a waveguide launch PCB 302. The radar 400 of FIG. 4 includes two antenna launch PCBs 404a and 404b coupled to the waveguide launch PCB 302 via a waveguide interconnect 402. The waveguide interconnect 402 is configured to allow multiple antenna launch PCBs 404a and 404b to be coupled. The use of multiple antenna launch PCBs 404a and 404b allow for a field of view greater than 180 degrees.

As most of the expensive components are located on the single launch board, an advantage to this design is that it can be common among many designs and provide the ability to leverage manufacturing cost benefits. Additionally, the interconnects can be manufactured as simple molded or plated (or other possibilities including stamped, etched, etc.) plates instead of the highly complex machined or molded shapes as shown in FIG. 2, where the molded shapes would be subject to potential warp concerns. Similarly, the final antenna boards could be unpopulated PCBs or other similar low-cost solutions, which only need to reroute the input from the interconnect section to a final antenna pattern.

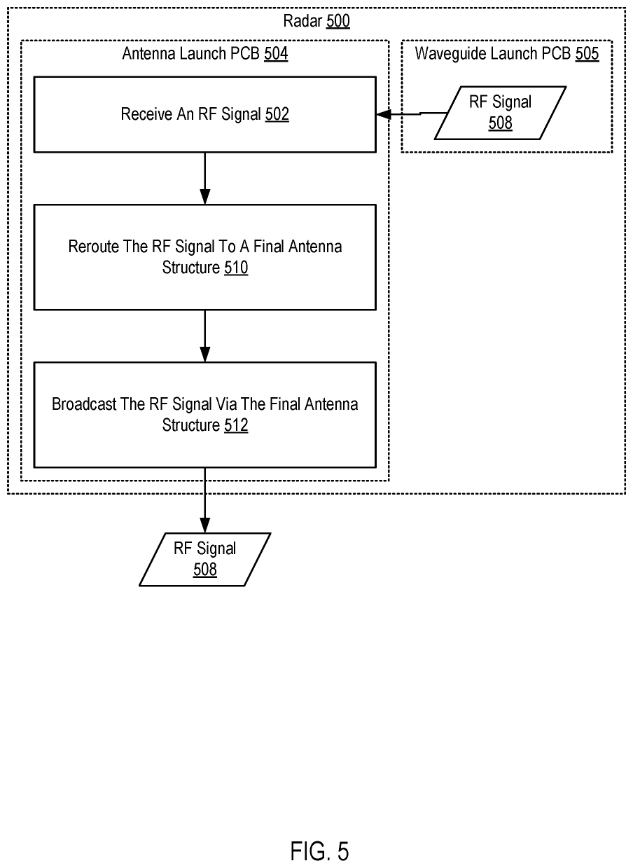

For further explanation, FIG. 5 shows a flowchart of an example method for a modular waveguide to printed circuit board (PCB) interconnected radar according to some embodiments of the present disclosure. The method of FIG. 5 may be performed, for example, by a radar 500. The radar 500 may be implemented, for example, as a radar 300 of FIG. 3 or a radar 400 of FIG. 4. The method of FIG. 5 includes receiving 502 (e.g., by an antenna launch PCB 504 from a waveguide launch PCB 505) an RF signal 508. The RF signal 508 may be received via a waveguide interconnect (e.g., a waveguide interconnect 304 or a waveguide interconnect 402). The RF signal 508 may be received by the antenna launch PCB 504 via one or more waveguide receive sections. The waveguide receive sections may include, for example, one or more circuit traces in an unpopulated antenna launch PCB 504.

The method of FIG. 5 also includes rerouting 510 the RF signal 508 to a final antenna structure (e.g., a final antenna structure 308). The RF signal 508 may be rerouted via one or more circuit traces coupling the waveguide receive sections to the final antenna structure. In some embodiments, the final antenna launch structure 308 includes one or more microstrip traces. In some embodiments, the final antenna launch structure 308 includes one or more stripline traces. The method of FIG. 5 also includes broadcasting 512 the RF signal 508 via the final antenna structure.

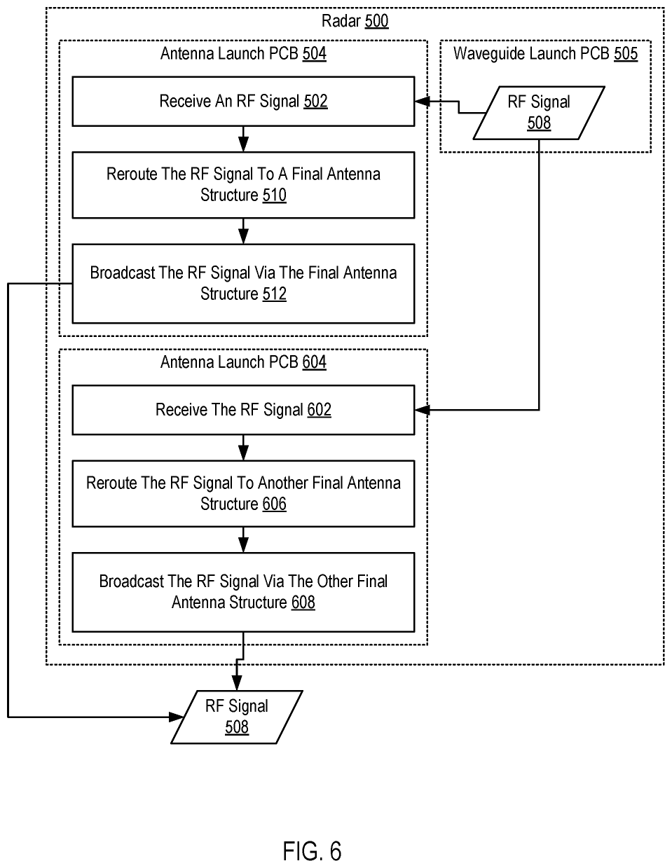

For further explanation, FIG. 6 shows a flowchart of an example method for a modular waveguide to printed circuit board (PCB) interconnected radar according to some embodiments of the present disclosure. The method of FIG. 6 is similar to FIG. 5 in that the method of FIG. 6 includes receiving 502 an RF signal 508; rerouting 510 the RF signal 508 to a final antenna structure; and broadcasting 512 the RF signal 508 via the final antenna structure.

The method of FIG. 6 differs from FIG. 5 in that the method of FIG. 6 includes receiving 602 (e.g., via another antenna launch PCB 604) the RF signal 508. The other antenna launch PCB 604 is coupled to the waveguide launch PCB 505 via the waveguide interconnect coupling the antenna launch PCB 504 to the waveguide launch PCB 505. The method of FIG. 6 also includes rerouting 606 the RF signal 508 to another final antenna structure and broadcasting 608 the RF signal 508 via the other final antenna structure. Thus, the RF signal 508 is broadcast using multiple antenna launch PCBs 504, 604, increasing the broadcast field of view of the radar 500.

In view of the explanations set forth above, readers will recognize that the benefits of designs according to the embodiments of the present disclosure include, but are not limited to:
A modular design that allows for lower cost of a microstrip or strip-line design.
Possibility of providing for a wider field of view using a single populated PCB.

Advantages and features of the present disclosure can be further described by the following statements:

1. A modular waveguide to printed circuit board (PCB) interconnected radar, the radar including: a waveguide launch PCB; a waveguide interconnect coupled to the waveguide launch PCB; and an antenna launch PCB coupled to the waveguide interconnect.

2. The radar of statement 1, wherein the antenna launch PCB is configured to: receive an RF signal via the waveguide interconnect; and broadcast the RF signal via a final antenna launch structure

3. The radar of statement 2 or statement 1, wherein the final antenna launch structure comprises one or more microstrip traces.

4. The radar of any of statements 1-3, wherein the final antenna launch structure comprises one or more stripline traces.

5. The radar of any of statements 1-4, wherein the antenna launch PCB comprises an unpopulated PCB.

6. The radar of any of statements 1-5, wherein the antenna launch PCB comprises one or more waveguide receive sections, a final antenna launch structure, and one or more circuit traces coupling the one or more waveguide receive sections to the final antenna launch structure.

7. The radar of any of statements 1-6, further comprising another antenna launch PCB coupled to the waveguide interconnect.

8. An apparatus for a modular waveguide to printed circuit board (PCB) interconnected radar, the apparatus including: a radar comprising: a waveguide launch PCB; a waveguide interconnect coupled to the waveguide launch PCB; and an antenna launch PCB coupled to the waveguide interconnect.

9. The apparatus of statement 8, wherein the antenna launch PCB is configured to: receive an RF signal via the waveguide interconnect; and broadcast the RF signal via a final antenna launch structure.

10. The apparatus of statement 9 or statement 8, wherein the final antenna launch structure comprises one or more microstrip traces.

11. The apparatus of any of statements 8-10, wherein the final antenna launch structure comprises one or more stripline traces.

12. The antenna of any of statements 8-11, wherein the antenna launch PCB comprises an unpopulated PCB.

13. The antenna of any of statements 8-12, wherein the antenna launch PCB comprises one or more waveguide receive sections, a final antenna launch structure, and one or more circuit traces coupling the one or more waveguide receive sections to the final antenna launch structure.

14. The antenna of any of statements 8-13, wherein the radar further comprises another antenna launch PCB coupled to the waveguide interconnect.

15. A method for a modular waveguide to printed circuit board (PCB) interconnected radar, the method including: receiving, by an antenna launch PCB, from a waveguide launch PCB via a waveguide interconnect, an RF signal; rerouting the RF signal to a final antenna structure of the antenna launch PCB; and broadcasting the RF signal via the final antenna structure.

16. The method of statement 15, wherein the final antenna launch structure comprises one or more microstrip traces.

17. The method of statement 16 or statement 15, wherein the final antenna launch structure comprises one or more stripline traces.

18. The method of any of statements 15-17, wherein the antenna launch PCB comprises an unpopulated PCB.

19. The method of any of statements 15-18, wherein the antenna launch PCB comprises one or more waveguide receive sections, a final antenna launch structure, and one or more circuit traces coupling the one or more waveguide receive sections to the final antenna launch structure.

20. The method of any of statements 15-19, wherein the method further comprises: receiving, by another antenna launch PCB, from the waveguide interconnect, the RF signal; rerouting the RF signal to another final antenna structure; and broadcasting the RF signal via the other final antenna structure.

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

What is claimed is:

1. A modular waveguide to printed circuit board (PCB) interconnected radar, the radar comprising:
a waveguide launch PCB;
a waveguide interconnect coupled to the waveguide launch PCB; and
an antenna launch PCB coupled to the waveguide interconnect.

2. The radar of claim 1, wherein the antenna launch PCB is configured to:
receive a radio frequency (RF) signal via the waveguide interconnect; and
broadcast the RF signal via a final antenna launch structure.

3. The radar of claim 2, wherein the final antenna launch structure comprises one or more microstrip traces.

4. The radar of claim 2, wherein the final antenna launch structure comprises one or more stripline traces.

5. The radar of claim 1, wherein the antenna launch PCB comprises an unpopulated PCB.

6. The radar of claim 5, wherein the antenna launch PCB comprises one or more waveguide receive sections, a final antenna launch structure, and one or more circuit traces coupling the one or more waveguide receive sections to the final antenna launch structure.

7. The radar of claim 1, further comprising another antenna launch PCB coupled to the waveguide interconnect.

8. An apparatus comprising:
a radar comprising:
a waveguide launch PCB;
a waveguide interconnect coupled to the waveguide launch PCB; and
an antenna launch PCB coupled to the waveguide interconnect.

9. The apparatus of claim 8, wherein the antenna launch PCB is configured to:
receive an RF signal via the waveguide interconnect; and
broadcast the RF signal via a final antenna launch structure.

10. The apparatus of claim 9, wherein the final antenna launch structure comprises one or more microstrip traces.

11. The apparatus of claim 9, wherein the final antenna launch structure comprises one or more stripline traces.

12. The apparatus of claim 8, wherein the antenna launch PCB comprises an unpopulated PCB.

13. The apparatus of claim 12, wherein the antenna launch PCB comprises one or more waveguide receive sections, a final antenna launch structure, and one or more circuit traces coupling the one or more waveguide receive sections to the final antenna launch structure.

14. The apparatus of claim 8, wherein the radar further comprises another antenna launch PCB coupled to the waveguide interconnect.

15. A method for using a modular waveguide to printed circuit board (PCB) interconnected radar the method comprising:
receiving, by an antenna launch PCB, from a waveguide launch PCB via a waveguide interconnect, an RF signal;
rerouting the RF signal to a final antenna structure of the antenna launch PCB; and
broadcasting the RF signal via the final antenna structure.

16. The method of claim 15, wherein the final antenna launch structure comprises one or more microstrip traces.

17. The method of claim 15, wherein the final antenna launch structure comprises one or more stripline traces.

18. The method of claim 15, wherein the antenna launch PCB comprises an unpopulated PCB.

19. The method of claim 18, wherein the antenna launch PCB comprises one or more waveguide receive sections, a final antenna launch structure, and one or more circuit traces coupling the one or more waveguide receive sections to the final antenna launch structure.

20. The method of claim 15, further comprising:
receiving, by another antenna launch PCB, from the waveguide interconnect, the RF signal;
rerouting the RF signal to another final antenna structure; and
broadcasting the RF signal via the other final antenna structure.
